(19) United States
(12) Patent Application Publication
(10) Pub. No.: US 2017/0161966 A1
(43) Pub. Date: Jun. 8, 2017

(54) Vehicle Diagnostic Device

(71) Applicant: Autoland Scientech Co., Ltd., Taichung City (TW)

(72) Inventor: Chung-Yi Huang, Taichung City (TW)

(21) Appl. No.: 15/181,880

(22) Filed: Jun. 14, 2016

(30) Foreign Application Priority Data
Apr. 27, 2015 (TW) 104113360

(51) Int. Cl. G07C 5/00; G07C 5/08

(52) U.S. Cl. CPC G07C 5/008; G07C 5/0808; G07C 5/0825

(57) ABSTRACT

A vehicle diagnostic device includes a body to which a switch, at least one connector, a display screen, a circuit board, a first I/O connection port, and a second I/O connection port are connected. The circuit board has a detection unit, an A/D converter unit, a processing unit and a display unit, and is connected to the at least one connector and the first and second I/O connection ports. The first I/O connection port is electronically connected to the ECU. The second I/O connection port is electronically connected to the operation device which reads the pre-set information from a remote storage device via internet so as to update or amend the ECU to be checked.

### BACKGROUND OF THE INVENTION

1. Fields of the Invention

The present invention relates to a diagnostic device, and more particularly, to a diagnostic device for detecting engine control unit and parts of vehicles.

2. Descriptions of Related Art

The conventional Engine Control Unit (ECU) is used to check the status of the engine of a vehicle to acknowledge the statuses of intake air, the fuel ejection and the ignition timing. Along with the development of the safety features of the modern vehicles such as CWFAB, PDFAB, LEW, ASC and CTC, all of these features are monitored by the ECU. The modern ECU is required to have more sophisticate functions and is more complicated.

Nevertheless, the factors and parameters of the vehicles manufacturers keep the factors and parameters as confidential information so that the ECUs of the different makes have different features to meet their own requirements. Therefore, the auto repair stores have to purchase many vehicle diagnostic devices so as to have the specific factors and parameters of different makes.

One of the known vehicle diagnostic devices uses a single duplicating member or a learning member to check a software card in the vehicle to get the necessary factors and parameters via internet. The software card is taken out from the vehicle and is updated via the internet. Therefore, the diagnostic device can have the proper information of the ECU, such that the car repair stores are able to deal with the problems of the vehicles of different brands with less cost.

However, the software card can be easily contaminated by grease and dirt during the steps, even worse, the software card may not function properly.

The present invention intends to provide a vehicle diagnostic device for vehicles so as to improve the shortcomings mentioned above.

### SUMMARY OF THE INVENTION

The present invention relates to a vehicle diagnostic device and comprises a body composed of two parts and a space is defined between the two parts. The body has a switch, at least one connector, and a display screen connected thereto. At least one connector is connected to the body and connected with parts to be detected. The circuit board is located in the space and has a detection unit, an A/D converter unit, a processing unit and a display unit. The detection unit is electronically connected with the at least one connector and receives analog signals from the at least one connector. The A/D converter unit is electronically connected with the detection unit and receives the analog signals, and transfers the analog signals into digital signals. The processing unit receives the digital signals and processes and compares the digital signals, and then transfers the results of the processing and comparing of the digital signals to the display unit which displays digitals or patterns on the display screen.

A first I/O connection port is electronically connected to the processing unit and connected to an Engine Control Unit (ECU) by a first wire set. Signals from the ECU are transferred to the processing unit. A second I/O connection port is electronically connected to the processing unit and connected to the Engine Control Unit (ECU). The second I/O connection port is connected to an operation device by a second wire set. The operation device is connected to a storage device by way of wired or wireless, so that the operation device receives the signals from the ECU and compares the signals from the ECU with the pre-set information in the storage unit so that the ECU is remotely updated or amended via the processing unit, the first I/O connection port and the first wire set.

The primary object of the present invention is to provide a vehicle diagnostic device that does not contaminate the software card, and the latest information of the vehicles can be obtained via Internet.

Another object of the present invention is to provide a vehicle diagnostic device that updates and amends the ECU electronically via internet.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIGS. 1 and 2 show the two different side vies of the vehicle diagnostic device of the present invention;

FIG. 3 shows the top view of the vehicle diagnostic device of the present invention;

FIG. 4 shows the arrangement of the parts of the vehicle diagnostic device of the present invention, and

FIG. 5 shows the block diagram of the vehicle diagnostic device of the present invention.

### DETAILED DESCRIPTION OF THE PREFERRED EMBODIMENT

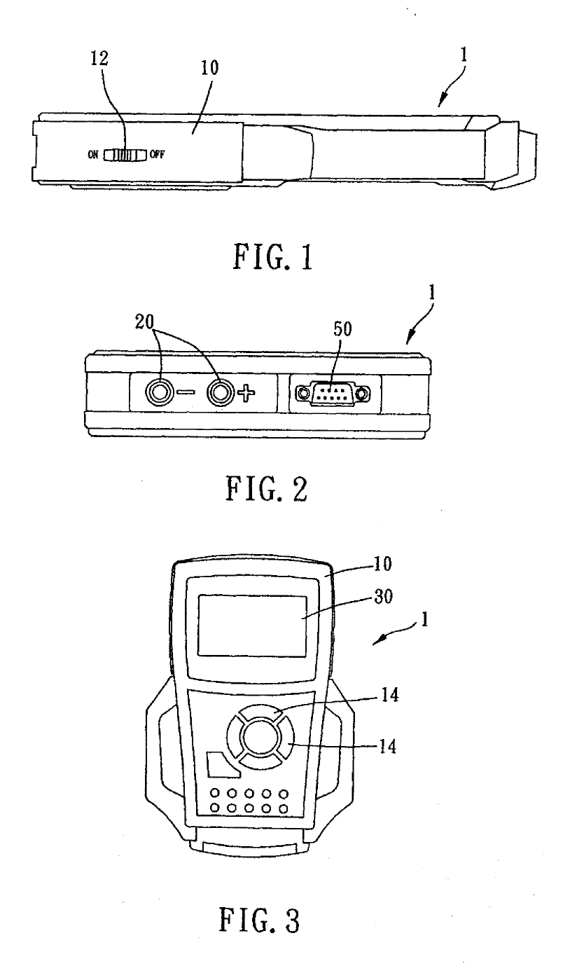

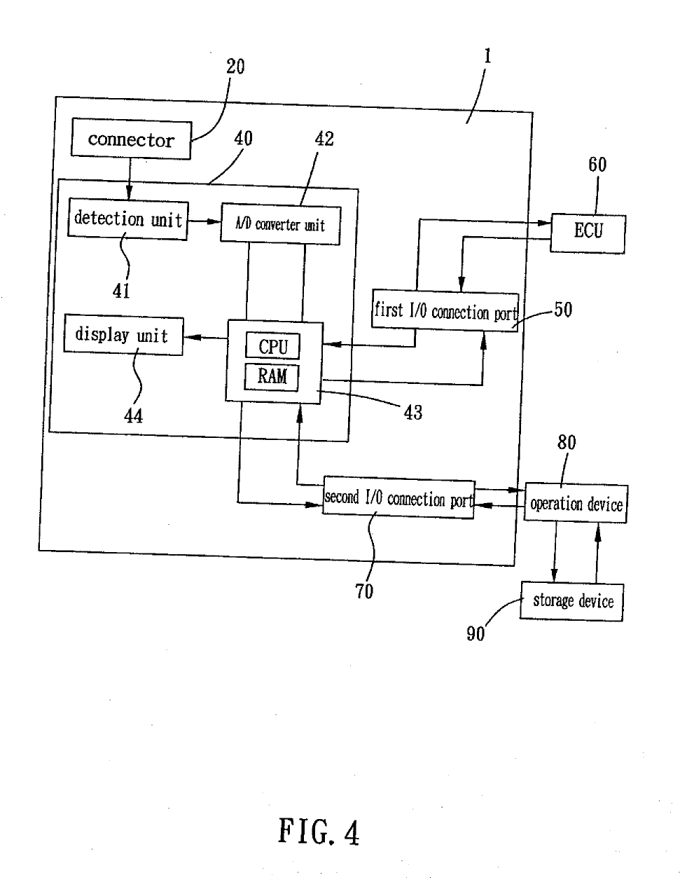

Referring to FIGS. 1 to 3, the vehicle diagnostic device 1 of the present invention comprises a body 10 composed of two plastic parts and a space is defined between the two parts. A switch 12, a function choosing portion 14 and at least one connector 20 are connected to the body 10. The user chooses the buttons of the function choosing portion 14 to activate a specific detection function according to the auto parts to be checked. The buttons can also be designed into different types.

The at least one connector 20 is connected to one side of the body 10 and includes a positive port and a negative port so that the probes of a multi-meter (Volt-Ohm meter) are inserted into the positive and negative ports to check the parts to be detected. The present invention can also be able to check the oxygen in the cylinders of the engine, the ignition angles, the operation speed of the cam/crank, the fuel ejection, the control of the ignition, the valve position, the idle control, the water check and the temperature of intake air by switching different buttons of the function choosing portion 14.

A display screen 30 is connected to the top of the body 10 and displays digitals or patterns. Preferably, the display screen 30 is an LCD screen.

A circuit board 40 is located in the space and has a detection unit 41, an A/D converter unit 42, a processing unit 43 and a display unit 44. The detection unit 41 is electronically connected with the at least one connector 20 and receives the analog signals from the at least one connector 20. The A/D converter unit 42 is electronically linked with the detection unit 41 and receives the analog signals, and transfers the analog signals into digital signals.

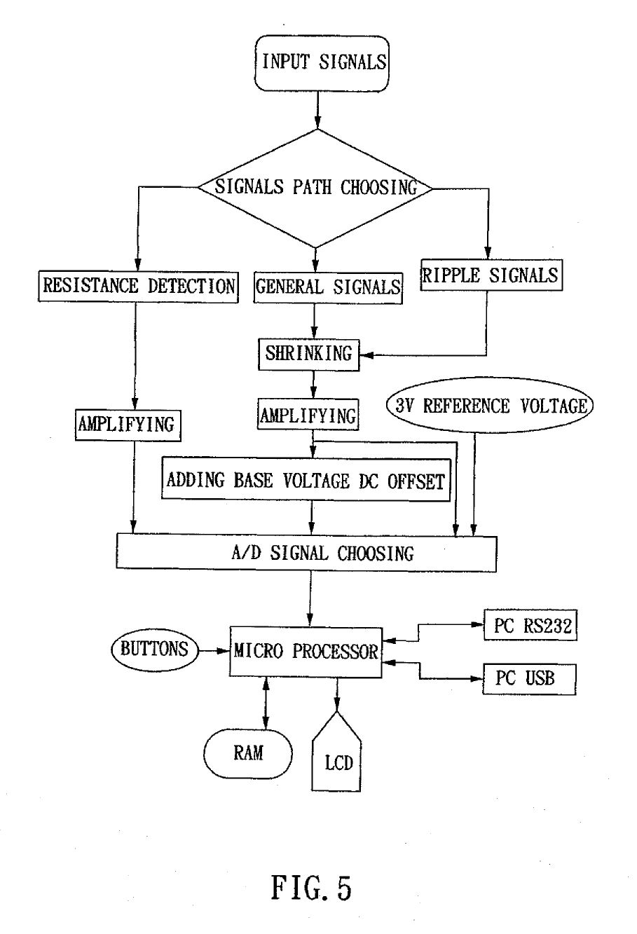

The processing unit 43 includes a CPU 431 and a RAM 432 for storing the results of calculation. The processing unit 43 receives the digital signals from the A/D converter unit 42 and processes and compares the digital signals, and then transfers the results of the processing and comparing of the digital signals to the display unit 44 which displays in forms of digitals or patterns on the display screen 30. The digits or patterns are displayed by the types of the input signals such as general signals, resistance signals or ripple signals (as shown in FIG. 5). The general signals and the resistance signals are displayed by digits, and the ripple signals are displayed by patterns. If the general signals, the resistance signals or the tipple signals is less than the pre-set value of 3 volts which is reference voltage, then these signals will be adjusted to 3 voltages to ensure the accuracy of the signals. The result is then converted into the digital signals by the A/D converter unit 42, and then calculated and judged by the CPU, and stored in the RAM. The result of the judgement is displayed on the display screen 30 in the forms of digits or patterns. The signals judged by the CPU 431 can also be linked to the ECU and reads the factors and parameters from the ECU via the RS232. The pre-set information of the software of the computers of different makes are then compared via the operation device and the storage device to obtain the correct information which is then sent to the CPU 431.

The vehicle diagnostic device 1 further comprises a first I/O connection port 50 which is located close to the at least one connector 20 and is electronically connected to the processing unit 43. The first I/O connection portion 50 is connected to an Engine Control Unit (ECU) 60 by a first wire set (not shown) which meets requirements of RS232 agreement. The signals such as the brad, the model and the year of make, from the ECU are transferred to the processing unit 43.

The vehicle diagnostic device 1 further comprises a second I/O connection port 70 which is electronically linked to the processing unit 43 and connected to the Engine Control Unit (ECU) 60. The second I/O connection port 70 is connected to an operation device 80 by a second wire set (not shown). The operation device 80 is connected to a storage device 90 by way of wired or wireless, so that the operation device 80 receives the signals from the ECU and compares the signals from the ECU 60 with pre-set information in the storage unit 90. According to the pre-set information in the storage unit 90, the ECU 60 is remotely updated or amended via the processing unit 43, the first I/O connection port 50 and the first wire set.

The first wire set meets requirements of RS232 agreement. The second wire set is a USB or other cables that are able to be connected to the computers. The operation device 80 is a personal computer, a laptop, a planar computer or a cellular phone. The storage device 90 is a hard disk in the personal computer, the laptop, the planar computer or the cellular phone. The operation device 80 reads the pre-set information in the storage device 90. Preferably, the storage device 90 is a remote servo hard disk. The operation device 80 of the personal computer or the laptop reads the pre-set information from the remote servo hard disk and transfers back the pre-set information via wired internet or wireless WIFI. The operation device 80 of the planar computer or the cellular phone reads the pre-set information from the remote servo hard disk and transfers back the pre-set information via wireless WIFI.

The latest information of the vehicles of different makes are stored in a remote storage device, and the present invention reads the latest information remotely by way of internet so as to process and compare the exist information of the vehicle and the pre-set information, such that the ECU 60 of the vehicle to be checked can be updated or amended without taking the software card out. The way that the present invention updates and amends the information of the ECU 60 does not contaminate the software card which does not need to be picked out from the vehicle so that the software card does not lost.

The present invention uses the at least one connector 20 to check the vehicle parts, and uses the first and second I/O connection ports 50, 70 to update and amend the ECU 60. The present invention is a multiple function diagnostic device.

While we have shown and described the embodiment in accordance with the present invention, it should be clear to those skilled in the art that further embodiments may be made without departing from the scope of the present invention.

What is claimed is:

1. A vehicle diagnostic device comprising:
a body composed of two parts and a space being defined between the two parts, a switch connected to the body;
at least one connector connected to the body and adapted to be connected with parts to be detected;
a display screen connected to the body for displaying digitals or patterns of the detected parts;
a circuit board located in the space and having a detection unit, an A/D converter unit, a processing unit and a display unit, the detection unit electronically connected with the at least one connector and receiving analog signals from the at least one connector, the A/D converter unit electronically connected with the detection unit and receiving the analog signals, and transferring the analog signals into digital signals, the processing unit receiving the digital signals and processing and comparing the digital signals, and then transferring results of the processing and comparing of the digital signals to the display unit which displays digitals or patterns on the display screen;
a first I/O connection port electronically connected to the processing unit and being connected to an Engine Control Unit (ECU) by a first wire set, signals from the ECU being transferred to the processing unit, and
a second I/O connection port electronically connected to the processing unit and being connected to the Engine Control Unit (ECU), the second I/O connection port connected to an operation device by a second wire set, the operation device being connected to a storage device by way of wired or wireless, so that the operation device receives the signals from the ECU and compares the signals from the ECU with pre-set information in the storage unit so that the ECU is remotely updated or amended via the processing unit, the first I/O connection port and the first wire set.

2. The vehicle diagnostic device as claimed in claim 1, wherein the body has a function choosing portion which is operated to choose different functions for diagnosing different parts.

3. The vehicle diagnostic device as claimed in claim 1, wherein the first wire set meets requirements of RS232 agreement, the second wire set is a USB, the operation device is a personal computer, a laptop, a planar computer or a cellular phone.

4. The vehicle diagnostic device as claimed in claim 3, wherein the storage device is a hard disk in the personal computer, the laptop, the planar computer or the cellular phone, the operation device reads the pre-set information in the storage device.

5. The vehicle diagnostic device as claimed in claim 3, wherein the storage device is a remote servo hard disk.

6. The vehicle diagnostic device as claimed in claim 5, wherein the operation device of the personal computer or the laptop reads the pre-set information from a remote servo hard disk and transfers back the pre-set information via wired internet or wireless WIFI.

7. The vehicle diagnostic device as claimed in claim 5, wherein the operation device of the planar computer or the cellular phone reads the pre-set information from a remote servo hard disk and transfers back the pre-set information via wireless WIFI.
